(19) United States
(12) Patent Application Publication
(10) Pub. No.: US 2024/0004444 A1
(43) Pub. Date: Jan. 4, 2024

(54) REST-OF-CHIP POWER OPTIMIZATION THROUGH DATA FABRIC PERFORMANCE STATE MANAGEMENT

(71) Applicants: Advanced Micro Devices, Inc., Santa Clara, CA (US); ATI Technologies ULC, Markham (CA)

(72) Inventors: Karthik Rao, Austin, TX (US); Indrani Paul, Austin, TX (US); Dana Glenn Lewis, Austin, TX (US); Brett Danier Anil Ramautarsingh, Markham (CA); Jeffrey Ka-Chun Lui, Markham (CA); Prasanthy Loganaathan, Markham (CA); Jun Huang, Markham (CA); Ho Hin Lau, Markham (CA); Zhidong Xu, Markham (CA)

(73) Assignees: Advanced Micro Devices, Inc., Santa Clara, CA (US); ATI Technologies ULC, Markham (CA)

(21) Appl. No.: 17/855,054

(22) Filed: Jun. 30, 2022

(51) Int. Cl. G06F 1/26

(52) U.S. Cl. CPC G06F 1/26

(57) ABSTRACT

Methods and systems are disclosed for managing performance states of a data fabric of a system on chip (SoC). Techniques disclosed include determining a performance state of the data fabric based on data fabric bandwidth utilizations of respective components of the SoC. A metric, characteristic of a workload centric to cores of the SoC, is derived from hardware counters, and, based on the metric, it is determined whether to alter the performance state.

### CROSS REFERENCE TO RELATED APPLICATIONS

This application is related to co-pending application entitled “Techniques for Reducing Processor Power Consumption”, Attorney Docket No. AMDATI-210723-US-ORG1, filed on the same date, which is incorporated by reference as if fully set forth herein.

### BACKGROUND

Computing devices have advanced power control systems that intelligently budget power available in a system to components of that system. Such power control systems are constantly being developed.

### BRIEF DESCRIPTION OF THE DRAWINGS

A more detailed understanding may be had from the following description, given by way of example in conjunction with the accompanying drawings wherein:

FIG. 1 is a block diagram of an example device containing SoC, based on which one or more features of the disclosure can be implemented;

FIG. 2 is a flowchart of an example baseline method for managing performance states of a data fabric of an SoC, based on which one or more features of the disclosure can be implemented;

FIG. 3 is a graph that illustrates SoC power consumption during video conferencing, based on which one or more features of the disclosure can be implemented;

FIG. 4 is a graph that illustrates data fabric performance state residency at various configurations of video conferencing, based on which one or more features of the disclosure can be implemented; and

FIG. 5 is a flowchart of an example method for managing performance states of a data fabric of an SoC, based on which one or more features of the disclosure can be implemented

### DETAILED DESCRIPTION

Components of a system on chip (SoC) draw power from multiple voltage rails of one voltage regulator. The total power supplied by the voltage regulator must be dynamically budgeted to the SoC components based on their respective workloads. Some of these components are designed to support operations at multiple performance states. Each performance state is associated with operating frequencies and voltages consistent with a certain level of performance. When a workload executed on a component demands lower latency or higher bandwidth, the component may satisfy such demand by operating at a performance state that corresponds to higher frequencies. As a result, the component will draw more power out of the voltage rail it is connected to, leaving less power available to other SoC components. The excess in power does not always translates to an overall improvement in the quality of service of a user application. For example, a video conferencing application, typically, generates concurrent workloads at multiple SoC components, including the data fabric that provides connectivity to these components. And, thus, power allocation to the data fabric should be managed without interfering with the performance of another SoC component, so that user experience would not be compromised.

Systems and methods are disclosed for managing performance states of a data fabric in an SoC. A data fabric, as the main provider of connectivity among components of the SoC, has a central system role. Techniques are disclosed for determining the performance states the data fabric (including associated components, such as memory controllers and physical layers) operates at, thereby reducing its power consumption. This reduced power consumption leaves more power available to other components of the SoC. Power that may be needed to satisfy those components' performance requirements.

Aspects of the present disclosure describe methods for managing performance states of a data fabric of an SoC. The methods comprise determining, by a power controller of the SoC a performance state of the data fabric. The methods further comprise deriving a metric characteristic of a workload executing on the cores of the SoC and altering, based on the metric, the performance state of the data fabric.

Aspects of the present disclosure also describe systems for managing performance states of a data fabric of an SoC. The systems comprise at least one processor and memory storing instructions. The instructions, when executed by the at least one processor, cause the processor: to determine, by a power controller of the SoC, a performance state of the data fabric, to derive a metric characteristic of a workload executing on the cores of the SoC, and to alter, based on the metric, the performance state of the data fabric.

Further aspects of the present disclosure describe a non-transitory computer-readable medium comprising instructions executable by at least one processor to perform methods for managing performance states of a data fabric of an SoC. The methods comprise determining, by a power controller of the SoC, a performance state of the data fabric. The methods further comprise deriving a metric characteristic of a workload executing on the cores of the SoC, and altering, based on the metric, the performance state of the data fabric.

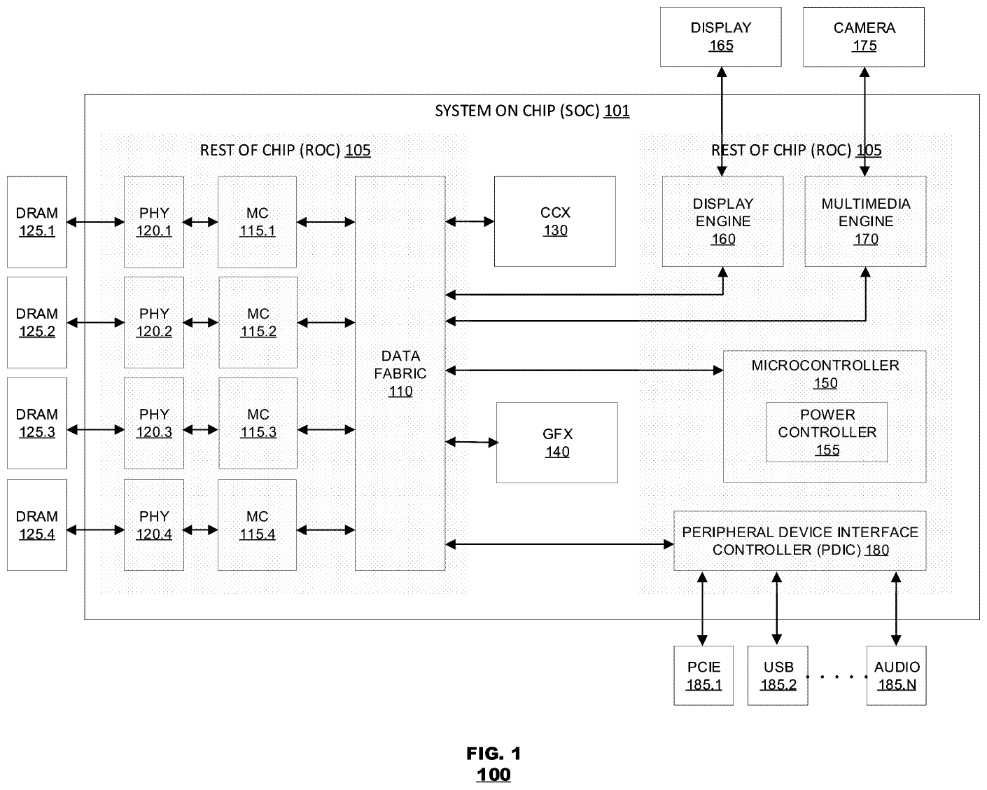

FIG. 1 is a block diagram of an example device 100 containing SoC 101. The SoC 101 includes components such as processors 130, graphical processing units (GPUs), a microcontroller 150, a display engine 160, a multimedia engine 170, and a peripheral device interface controller (PDIC) 180. Other components (not shown) may be integrated into the SoC 101. The processor 130, controlled by an operating system (OS) executed thereon, is configured to run applications and drivers. The GPU 140 can be employed by those applications (via the drivers) to execute computational tasks, typically involving parallel computing on multidimensional data (e.g., graphical rendering and/or processing of image data). The microcontroller 150 is configured to perform system level operations—such as assessing system performance based on performance hardware counters, tracking the temperature of the SoC's components, and processing information from the OS—based on which it allocates power to the different components of the SoC, for example. The SoC 101 further includes a data fabric 110, memory controls (MC) 115.1-4 (or 115), and physical layers (PHYs) 120.1-4 (or 120) that provide access to memory, e.g., DRAM units 125.1-4 (or 125). The fabric data 110 includes a network of switchers that interconnect the SoC components 130, 140, 150, 160, 170, 180 to each other. The data fabric 110 also provides the SoC components with read and write access to the DRAM units 125. The data fabric 110, memory controls 115, physical layers 120, display engine 160, multimedia engine 170, microcontroller 150, and PDIC 180 are referred to herein as belonging to the Rest-of-Chip (ROC) 105 (denoted by the patterned region 105 of FIG. 1).

The device 100 of FIG. 1 can be a mobile computing device, such as a laptop. In such a case, the Input/Output (I/O) ports 185.1-N (or 185) of the device—including, for example, peripheral component interconnect express (PCIE) port 185.1, universal serial bus (USB) port 185.2, and/or audio port 185.N—can be serviced by the peripheral device interface controller 180 of the SoC 101. The display 165 of the device can be connected to the display engine 160 of the SoC 101. The display engine 160 can be configured to provide the display 165 with rendered content (e.g., generated by the GFX 140) or to capture content presented on the display 165 (e.g., to be stored in the DRAM 125 or to be delivered by the PDIC 180 via one of the I/O ports 185 to a destination device or server). The camera 175 of the device can be connected to the multimedia engine 170. The multimedia engine 170 can be configured to process video captured by the camera 175, including encoding the captured video (e.g., to be stored in the DRAM 125 or to be delivered by the PDIC 180 via one of the I/O ports 185 to a destination device or server).

The SoC 101 is powered by voltage rails provided by a voltage regulator. One voltage rail, namely, the core voltage rail, can supply power to the processor 130 and the GPU 140 components, while another voltage rail, namely, the SoC voltage rail can supply power to other components of the SoC. The SoC voltage rail primarily supplies power to the ROC 105. The voltage rails supply the SoC 101 with a total power level that is limited (by design) to the TDP (Thermal Design Power). And, thus, power drawn by the SoC components, and the resulting respective performance levels, are coupled to each other, meaning, for example, that when one component draws additional power, less power is available to another component. It is advantageous to dynamically budget the power allocated to the SoC components based on operating conditions (e.g., operating on battery power mode or when plugged in) and based on performance requirements (e.g., of executed workloads).

The data fabric 110, the main facilitator of connectivity among the SoC components and between the SoC components and the DRAM units 125, is engaged at different levels, depending on the nature of the workload that is executed by the SoC 101. The data fabric 110 supports multiple performance states (P-states) used to address different levels of engagement. To maintain low power consumption while satisfying performance requirements, the setting of the data fabric performance states must be properly managed. Furthermore, managing the data fabric performance states (that affect the power consumed from the SoC voltage rail, supplying power to the ROC) should be in conjunction with power management of other SoC components, for example, the power management of the cores 130 (that affect the power consumed from the core voltage rail, supplying power to the processor 130 and the GPU 140 components).

Regarding the performance states supported by the data fabric 110, each is associated with a combination of frequencies (tied to the voltage that is drawn from the ROC voltage rail). These frequencies can be frequencies that correspond to the clock of the data fabric 110 itself (that is, fabric clock (FCLK)), to the clock of the memory controllers 115 (that is, memory controller clock (UCLK)), or to the clock of the DRAM units 125 (that is, the DRAM memory clock (MEMCLK)). The specific combination of frequencies associated with each performance state can vary (depending, for example, on the speed of the DRAM units 125) and can be determined at boot time or at any other time. In other words, different performance states can differ by one or more frequency values, and the determination of any particular frequency value for any particular performance state can be made in any technically feasible manner, such as at boot time (e.g., based on stored values) or in any other manner. In an example, the performance states can be defined by the following combination of frequencies:

P0=(f_{FCLK}⁰,f_{UCLK}⁰,f_{MEMCLK}⁰) (1)

P1=(f_{FCLK}¹,f_{UCLK}¹,f_{MEMCLK}¹) (2)

P2=(f_{FCLK}²,f_{UCLK}²,f_{MEMCLK}²) (3)

P3=(f_{FCLK}³,f_{UCLK}³,f_{MEMCLK}³) (4)

In other words, each of performance states P0-P3 has a fabric clock, memory controller clock, and DRAM memory clock value. The combination of frequencies associated with a performance state can be selected to meet a particular optimization objective. For example, state P3 can be tuned (e.g., by a manufacturer at manufacture time or via hardware, software, or firmware updates to an already-sold device) to target the lowest performance requirement, state P2 can be tuned to satisfy intensive bandwidth utilization (e.g., by the graphics 140), state P1 can be tuned to satisfy latency sensitive applications, and state P0 can be tuned to satisfy applications requiring both low latency and high bandwidth. Thus, during its active states, when the data fabric 110 is set to operate at a P0 state, maximum power is consumed by the data fabric from the SoC voltage rail, while when the data fabric 110 is set to operate at a P3 state, minimum power is consumed by the data fabric from the SoC voltage rail.

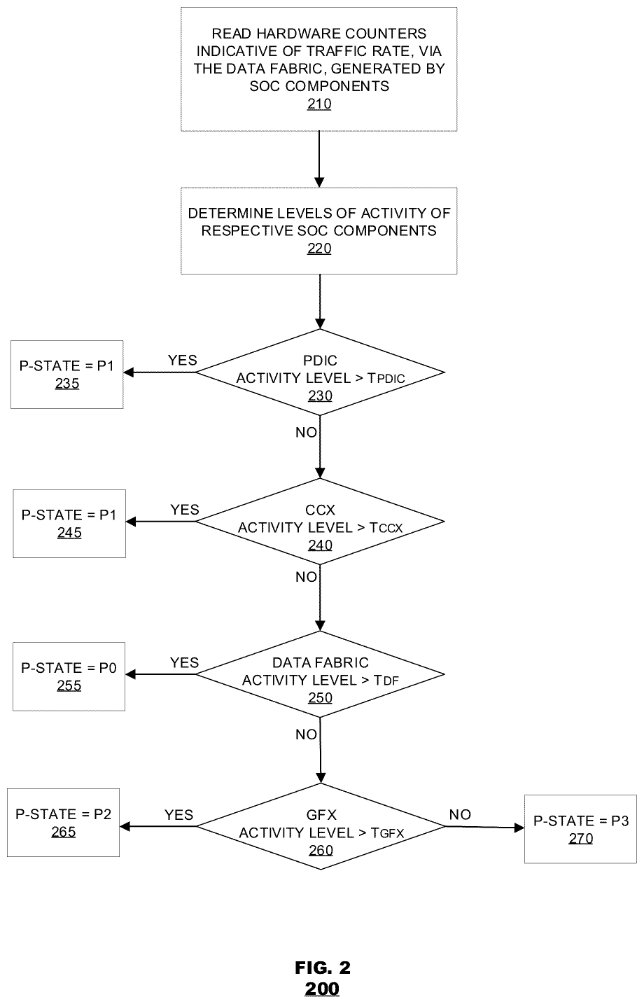

In an aspect, a power controller 155 is configured to dynamically manage the performance states of the data fabric 110. The power controller 155, can be a component of the microcontroller 150, the functionality of which can be implemented by software, firmware, or hardware. A method to dynamically determine the performance state of the data fabric 110, referred to herein as a “baseline” performance state determination method, is designed to set the performance state of the data fabric without accounting for the effect of such performance state on the performance of the end-user's application, as described further below, in reference to FIG. 2.

FIG. 2 is a flowchart of an example baseline method 200 for managing the performance states of the data fabric 110 of the SoC 101. The method 200 determines the data fabric performance states based on activity level measures of respective components of the SoC 101. The method 200 begins, in step 210, determining the amount of traffic on the data fabric 110. In some examples, this determination is made by reading hardware counters. In some examples, these hardware counters are SoC registers (not shown), designed to store data indicative of rate-of-traffic, via the data fabric 110, generated by the SoC components. For example, these counters may be read-counters and/or write-counters associated with each of the SoC components (such as processor 130, GPU 140, and PDIC 180) that indicate the rate of access, by each component, to the DRAM units 125. In step 220, levels of activity in respective SoC components are determined. In some examples, this information is determined based on data read from the hardware counters. In some examples, the level of activity for a component is a value that is derived from the rate of access by that component over the data fabric. In some examples, the level of activity is proportional to the access rate (e.g., is equal to the access rate multiplied by a weighting factor). In other examples, the level of activity has a more complicated relationship to the access rate. In some examples, the level of activity increases when the access rate increases and decreases when the access rate decreases. Any technically feasible means for determining the level of activity based on the access rate is contemplated herein.

According to the determined levels of activity, the baseline method 200 determines the performance state of the data fabric 110 as follows. If the level of activity of the peripheral device interface controller 180 is above a PDIC activity threshold (sometimes referred to as “T_{PDIC}”) (step 230), then the data fabric will be set to a P1 state 235. Otherwise, if the level of activity of the processor 130 is above a processor activity threshold (sometimes referred to as “T_{CCX}”) (in step 240), the data fabric will be set to a P1 state 245. Otherwise, if the level of activity of the data fabric 110 is above a data fabric threshold (sometimes referred to as “T_{DF}”) (in step 250), the data fabric will be set to a P0 state 255. The level of activity of the data fabric may be derived based on a combination of the levels of activity of the other components of the SoC (e.g., processor 130, GPU 140, and PDIC 180). If the level of activity of the data fabric 110 is not above a threshold T_{DF}, then, if the level of activity of the GPU 140 is above a GPU activity threshold (sometimes “T_{GFX}”) (step 260), the data fabric will be set to a P2 state 265. Otherwise, the data fabric will be set to a P3 state 270. The thresholds T_{PDIC}, T_{CCX}, T_{DF}, and T_{GFX} can be predetermined based on experimentation. In sum, the data fabric is set to a power state that is based on the level of activity of various components of the SoC, and thresholds associated with those components.

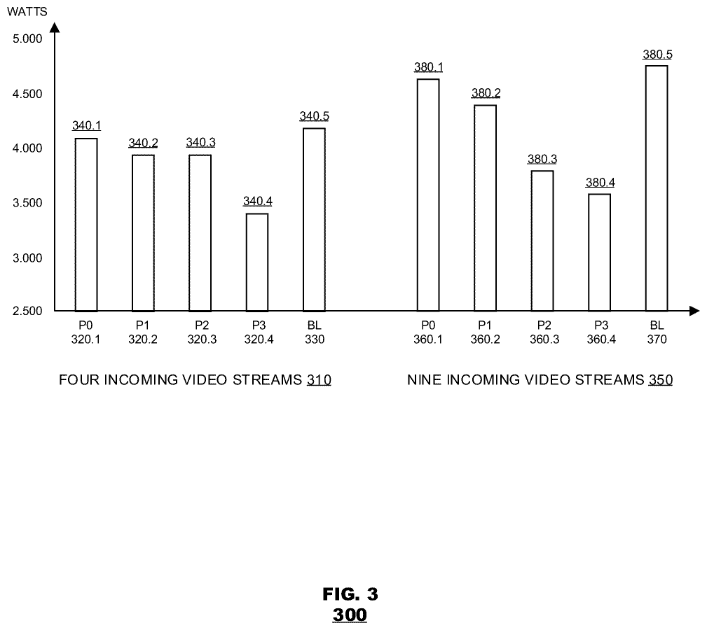

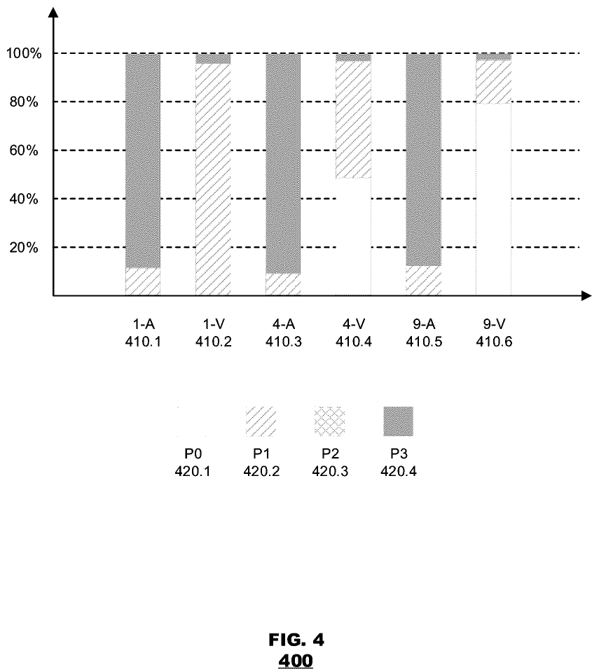

The power consumed by the data fabric 110 is illustrated in FIG. 3 and FIG. 4, which illustrates the SoC 101 performing a video conferencing workload. Video conferencing applications are demanding applications. Such applications, especially when used by a user of the device 100 to video conference with multiple participants, tend to highly engage many of the SoC components. During such conferencing, the processor 130 runs the conferencing application and employs the other SoC components that communicate via the data fabric 110. The display engine 160 decodes and drives the display of the incoming video streams of the remote conference participants. The multimedia engine 170 processes the user's video captured by the camera 175 (e.g., including enhancing the captured video using the GPU 140) and encodes it before sending it out, via one of the I/O ports 185, to the other conference participants using the PDIC 180. In addition to interconnecting the SoC components, the data fabric 110 provides access to the DRAM units 125 during the conference for writing and reading of intermediate processed data that may be generated by the SoC components. When the SoC 101 is employed for video conferencing, allocation of power across the SoC components can affect their performance and the overall user experience, as discussed further below.

FIG. 3 illustrates an SoC power consumption graph 300 during video conferencing, according to an example. More specifically, a video conferencing application is employed by the SoC 101 in two different configurations 310, 350. For each configuration, the total power consumed by the SoC (operating in a battery mode) is illustrated with the data fabric 110 set to operate at different performance states. In a first configuration 310, where four incoming video streams of remote participants are processed by the SoC 101, the power levels consumed by the SoC during conferencing 340.1-4 are shown when the performance states of the data fabric 110 are set to state P0 320.1, state P1 320.2, state P2 320.3, and state P3 320.4. The power level consumed by the SoC during conferencing 340.5 when the performance states of the data fabric 110 is determined by the baseline method 200 is also shown as BL 330. Similarly, in a second configuration 350, where nine incoming video streams of remote participants are processed by the SoC 101, the power levels consumed by the SoC during conferencing 380.1-4 are shown when the performance states of the data fabric 110 were set to state P0 360.1, state P1 360.2, state P2 360.3, and state P3 360.4. The power level consumed by the SoC during conferencing 380.5 when the performance states of the data fabric 110 is determined by the baseline method 200 is also shown as BL 370.

Based on a comparison of the consumed power levels, it can be seen that the largest amount of power is consumed by the SoC when the baseline method is employed (e.g., the power level 340.5 at BL 330 compared with the power level 340.4 at state P3 320.4 in the first configuration 310 and the power level 380.5 at BL 370 compared with the power level 380.4 at state P3 360.4 in the second configuration 350). Additionally, it is observed that the quality of service during the video conferencing when employed with respect to performance states P0, P1, P2, P3, and performance states as determined by the baseline method BL is comparable and is not noticeably compromised when a lower performance state is employed. It may therefore be concluded that the baseline method 200 is too aggressive in its selection of performance states, leading to higher overall power consumption.

Some other workloads, such as multi-threaded benchmark applications, when executed on the SoC (while operating in AC or in DC power modes) and when the data fabric performance state was lowered to state P3, results in performance improvement compared to when the data fabric performance state is set to state P1, as set by the baseline method 200. This may seem counter-intuitive, as higher performance is expected when the data fabric is set to operate at the higher frequencies of state P1. However, selecting a performance state that corresponds to higher frequencies results in more power being drawn from the SoC voltage rail that feeds the data fabric on account of power available for the cores 130 (and other SoC components) that are fed by the core voltage rail, leading to lower core clock frequencies, and, thus, to lower performance. Thus, a performance state that corresponds to lower frequencies results in better overall performance of the system.

FIG. 4 illustrates data fabric performance state residency 400 at various configurations of video conferencing, according to an example. In this example, a video conferencing application is executed by the SoC 101, using the baseline method 200 to set the data fabric performance states. As shown in FIG. 4, sessions of video conferencing are illustrated using configurations where: one audio stream 1-A 410.1, one video stream 1-V 410.2, four audio streams 4-A 410.3, four-video streams 410.4, nine audio streams 9-A 410.5, and nine video streams 9-V 410.6 are processed by the SoC 101. The performance state residency for each configuration, that is, the performance states selected by the baseline method 200, are also shown in FIG. 4. For example, in a configuration of four incoming video streams, 4-V 410.4, the performance state residency is about 49% state P0, 47% state P1, and 4% state P3, while in a configuration of nine incoming video streams, 9-V 410.6, the performance state residency is about 79% state P0, 17% state P1, and 4% state P3. According to this example information, there is excessive power consumption due to longer P0 state and P1 state residencies without the benefit of gaining improvement in service quality. The service quality of video conferencing can be determined, for example, by measuring the rate of frame drops in the incoming video streams.

Thus, the baseline method 200, in basing its selection of data fabric performance states primarily on the bandwidth utilizations of respective SoC components, is power inefficient. This is because the baseline method 200 tends to be aggressive—that is, it tends to select performance states that correspond to higher frequencies than necessary to secure a sufficient quality of service. To improve the efficiency of power allocation and overall consumption in the SoC 101, a technique is disclosed herein that classifies the cores' workload, based on which the data fabric performance states are determined. Classifying of the cores' 130 workloads is performed by periodically measuring the cores' levels of activity and associated memory traffic. To that end, hardware counters are utilized that record the cores' Instructions-Per-Cycle (IPC) or Instructions-Per-Second (IPS) and DRAM request latencies, as explained further below.

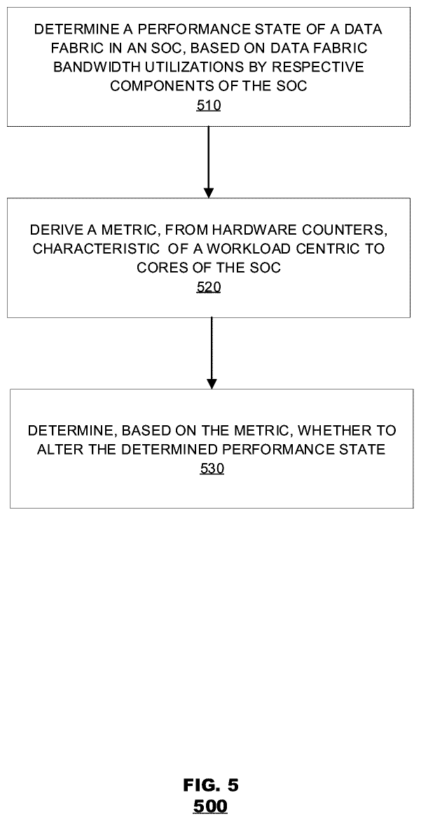

The SoC 101 contains various hardware counters, that is, registers designed to record real-time data that allow for the monitoring of respective system activities or system performance. The power controller 155 is configured to read such counters periodically. The data read from the counters are, typically, filtered over time, and then used to derive one or more metrics. The derived metrics are designed to be characteristic of the nature of the workload experienced by the cores 130. For example, certain hardware counters, namely, IPC (or IPS) counters are designed to monitor the IPC (or IPS) associated with respective cores 130. Other hardware counters, namely, Leading Load (LL) stall counters, are designed to monitor the leading load (“LL”) stalls. A leading load stall is a stall that occurs when a first non-speculative load misses in a cache. This stall is called “leading load” because many loads may be in flight, waiting to be serviced by the last level cache, but the first one (the “leading load”) that misses in such a situation is the one that causes a stall in the processor (where the stall occurs to allow the cache miss to be serviced). Counting leading load stalls is a way to characterize performance of a workload. For example, the more leading load stalls that occur, the worse the performance will be. Thus, utilizing metrics derived from hardware counters, such as the IPC (or IPS) counters and the LL stall counters, the workload that is central to the cores 130 (i.e., core-centric workload) can be characterized. Based on such characterization, a determination may be made, for example, that the data fabric performance state (as determined by the baseline method 200) should be altered to a performance state that corresponds to lower frequencies, and, thereby, reduce the power consumed by the data fabric and its associated components, as further described with reference to FIG. 5.

FIG. 5 is a flowchart of an example method 500 for managing performance states of a data fabric in an SoC 101. In some examples, the power controller 155 performs some or all of the steps of the method 500. The method 500 begins, in step 510, where a performance state of the data fabric is determined based on data fabric bandwidth utilizations by respective components in the SoC 101. For example, by employing the baseline method 200 described in reference to FIG. 2. In step 520, a metric is derived from hardware counters. The metric characterizes the workload that is centric to the processor 130, of the SoC 101. Then, based on the derived metric, in step 530, it is determined whether to alter the performance state that was determined in step 510. For example, for a certain core-centric workload, characterized by the derived metric, the determined data fabric performance state may be altered to a performance state that corresponds to lower operating frequencies. Thus, if a performance state P0 is determined in step 510 (e.g., corresponding to the operating frequencies of equation (1)), then, based on the derived metric, it may be altered into state P3 (e.g., corresponding to the lower frequencies of equation (4)). Operating at the latter set of frequencies, the data fabric 110 consumes less power from the SoC voltage rail, leading to a reduced total power consumption, and, potentially, making the power saved available to the usage of other components (such as the GFX 140).

Method 500 uses a metric to classify the workload centric to the cores of the processor 130. Based on the classification, the core-centric workload can be associated with key applications. Such a metric can be derived based on core-metrics, each of which is associated with one core in the processor 130. A core-metric, associated with a core, can be dynamically derived from a hardware counter associated with that core. Such a counter can be sampled periodically (e.g., at a sampling rate of a millisecond) and at each point in time t₀, samples within a time neighborhood (a time window positioned relative to t₀) can be filtered, resulting in a dynamic core-metric, representative of the data collected by the counter at the time neighborhood of t₀.

Thus, a core-metric—an “instruction rate core metric” can be derived from a core's IPC (or IPS) counter. Such a core-metric measures the rate of instructions processed by a core. It can be computed as a function of the filtered samples of the core's IPC (or IPS) counter. Instruction rate core metrics of respective cores 130 can then be combined to obtain a metric M_{InsRate} that can be used by method 500 to classify the workload centric to the cores of the processor 130. For example, for N cores, M_{InsRate} can be computed as:

M_{InsRate}=1/NΣₙ₌₁^{N}InsRate[n]. (5)

Another core-metric can be derived from a core's LL stall counter. Such a core-metric, namely, a leading load stall core-metric, measures the ratio of time that a core is stalling. It can be computed as a function of the filtered samples of the core's LL stall counter. The leading load stall core metrics of respective cores 130 can then be combined to obtain a metric M_{LLStall} that can be used by method 500 to classify the workload centric to the cores of the processor 130. For example, for N cores, M_{LLStall} can be computed as:

M_{LLStall}=1/NΣₙ₌₁^{N}LLStall[n]. (6)

Yet another metric, representative of the level of activity in a core, namely, a memory latency metric (MLM) metric, can be derived. This metric, M_{MLM}, can be computed as a function of the instruction rate core metric and the leading load stall core metric. For example, for N cores, M_{MLM} can be computed as the product of the instruction rate core metrics and the leading load stall core metric, as follows:

M_{MLM}=1/NΣₙ₌₁^{N}LLStall[n]·InsRate[n]. (7)

where LLStall is the leading load stall core metric and InsRate is the instruction rate core metric.

Hence, a metric, formulated, for example, based on M_{InsRateMetric}, M_{LLStallMetric}, M_{MLM}, or a combination thereof, can be used by the method 500 to dynamically characterize the workload executed by the cores 130. In an aspect, the metric can detect a pattern that is indicative of a first class of workloads characterized by low core activity and low memory activity, for example. In another aspect, the metric can detect a pattern that is indicative of a second class of workloads characterized by high core activity and moderate memory activity, for example. Based on experimentations, classes of workloads can be identified that are associated with key applications. In an example, the first class of workloads is typical of video conferencing applications while the second class of workloads is typical of multithreaded applications. In some examples, the power controller 155 has access to workload characterizing data that indicates, for a set of workloads, a set of characterizing values. In the event that the power controller 155 detects that the operating conditions of the device 100 meets the set of characterizing values for a workload, the power controller 155 determines that the device 100 is executing that workload. In some examples, the workload characterizing data also indicates what performance state to set the device 100 to in the event that the associated workload is detected. In such examples, the power controller 155 sets the device to that performance state in the event that such workload is detected. In summary, the power controller 155 operates the device according to the “baseline” in the event that a workload is not detected, and in the event that a workload is detected, the power controller 155 sets the performance state to a lower value than what the baseline would indicate. In some examples, this lower value is explicitly indicated by a set of data associated with the detected workload.

Dynamically controlling the performance states that the data fabric 110 is operating at, as described above, effectively controls the power consumed by the data fabric 110 and associated components 115, 120, 125. That is because each performance state determines the clock frequencies of the DRAM 125 and the memory controllers 115 in addition to the clock frequencies of the data fabric 110 (see equations (1)-(4)). Thus, the performance state the data fabric is set to significantly affects the voltage drawn from the SoC voltage rail. Excess power consumption by components fed by the SoC voltage rail occurs as a result of power that can be consumed by components that are fed by other voltage rails, such as components that are fed by the core voltage rail (i.e., the processor 130 and the GPU 140). Optimizing the data fabric performance states (as described herein with respect to FIGS. 1, 2, and 5) according to core-centric workloads, prevents allocating excess power to the data fabric and prevents setting it to operate at high frequencies that provide no quality of service increases. In an example, when a core-centric workload is generated by the execution of a video conferencing application, reducing the performance state (from P1 or P0 when four or nine incoming video streams are processed) to a P3 state reduces the power consumed by the ROC without an observable reduction in the quality of service (e.g., frame drops). Moreover, the SoC fan is not likely to start spinning when less power is consumed during video conferencing, thereby improving the overall user experience.

It should be understood that many variations are possible based on the disclosure herein. Although features and elements are described above in particular combinations, each feature or element can be used alone without the other features and elements or in various combinations with or without other features and elements.

Future SoCs are expected to be heterogeneous, that is, SoC components may include, for example, CPUs, GPUs, custom neural network engines, custom image processing engines, and/or programmable FPGAs—all manufactured as different parts of a single SoC package. Since the power consumption, the performance, and the thermal state of such SoC components and of the data fabric are coupled, the techniques presented in this application can be extended to such heterogeneous SoCs. Techniques disclosed herein for managing performance states of a data fabric can be applied in conjunction with any key applications (executed at various rates, either sequentially or simultaneously) that utilize such heterogeneous SoCs' components.

The methods provided can be implemented in a general-purpose computer, a processor, or a processor core. Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such as instructions capable of being stored on a computer readable media). The results of such processing can be mask works that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general-purpose computer or a processor. Examples of a non-transitory computer-readable medium include read only memory (ROM), random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for managing performance states of a data fabric of a system on chip (SoC), comprising:
determining, by a power controller of the SoC, a performance state of the data fabric;
deriving a metric characteristic of a workload executing on the cores of the SoC; and
altering, based on the metric, the performance state of the data fabric.

2. The method of claim 1, wherein altering the performance state of the data fabric comprises setting a new performance state that utilizes lower operating frequencies.

3. The method of claim 1, wherein altering the performance state of the data fabric comprises setting a new performance state that utilizes a lowest operating frequency out of operating frequencies of a set of performance states that the data fabric can occupy.

4. The method of claim 1, wherein the determining, based on the metric, whether to alter the determined performance state comprises:
classifying, based on the metric, the workload according to applications that generated the workload.

5. The method of claim 1, wherein determining the performance state of the data fabric is performed based on data fabric bandwidth utilizations of one or more components of the SoC.

6. The method of claim 1, wherein the deriving of the metric comprises:
for each core of the cores:
sampling data stored in a counter, of the hardware counters, associated with the core, and
determining a core-metric, associated with the core, as a function of the samples; and
deriving the metric based on the determined core-metrics associated with the cores.

7. The method of claim 1, wherein counters, of the hardware counters, store data representative of a rate of instructions processed by respective cores.

8. The method of claim 1, wherein counters, of the hardware counters, store data representative of a ratio of time a respective core, of the cores, is stalling.

9. A system for managing performance states of a data fabric of an SoC, comprising:
at least one processor; and
memory storing instructions that, when executed by the at least one processor, cause the processor to:
determine, by a power controller of the SoC, a performance state of the data fabric,
derive a metric from one or more hardware counters, and
alter, based on the metric, the performance state of the data fabric.

10. The system of claim 9, wherein altering the performance state of the data fabric comprises setting a new performance state that utilizes lower operating frequencies.

11. The system of claim 9, wherein altering the performance state of the data fabric comprises setting a new performance state that utilizes a lowest operating frequency out of operating frequencies of a set of performance states that the data fabric can occupy.

12. The system of claim 9, wherein the determining, based on the metric, whether to alter the determined performance state comprises:
classifying, based on the metric, the workload according to key applications that generated the workload.

13. The system of claim 9, wherein determining the performance state of the data fabric is performed based on data fabric bandwidth utilizations of one or more components of the SoC.

14. The system of claim 9, wherein the deriving of the metric comprises:
for each core of the cores:
sampling data stored in a counter, of the hardware counters, associated with the core, and
determining a core-metric, associated with the core, as a function of the samples; and
deriving the metric based on the determined core-metrics associated with the cores.

15. The system of claim 9, wherein counters, of the hardware counters, store data representative of a rate of instructions processed by respective cores.

16. The system of claim 9, wherein counters, of the hardware counters, store data representative of a ratio of time a respective core, of the cores, is stalling.

17. A non-transitory computer-readable medium comprising instructions executable by at least one processor to perform a method for managing performance states of a data fabric of an SoC, the method comprising:
determining, by a power controller of the SoC, a performance state of the data fabric;
deriving a metric from one or more hardware counters; and
altering, based on the metric, the performance state of the data fabric.

18. The medium of claim 17, wherein altering the performance state of the data fabric comprises setting a new performance state that utilizes lower operating frequencies.

19. The medium of claim 17, wherein counters, of the hardware counters, store data representative of a rate of instructions processed by respective cores.

20. The medium of claim 17, wherein counters, of the hardware counters, store data representative of a ratio of time a respective core, of the cores, is stalling.
